(19) United States
(12) Patent Application Publication
(10) Pub. No.: US 2009/0129638 A1
(43) Pub. Date: May 21, 2009

(54) Method of providing automatic sorting packing service sorting photo images according to characters in photo images and kiosk providing the automatic sorting packing service

(75) Inventor: Won-jung Kim, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/287,842

(22) Filed: Oct. 14, 2008

(30) Foreign Application Priority Data
Nov. 20, 2007 (KR) 10-2007-0118518

(51) Int. Cl. G06K 9/00

(52) U.S. Cl. 382/118

(57) ABSTRACT

A method of providing an automatic sorting packing service sorting photo images according to characters contained therein and a kiosk providing the automatic sorting packing service sorting according to characters are provided. The method includes: extracting a characteristic of each character from a face area of each photo image for which printing has been requested; and determining whether a detected character is a new character by comparing the extracted characteristic with a characteristic stored in a database. If the detected character is determined to be a new character, the extracted characteristic is stored in the database, a new packing line is allocated to the detected character, and a corresponding photo image is added to the allocated packing line. If the detected character is determined to be a character that has previously been recorded in the database, the corresponding photo image is added to the packing line of the detected character.

### CROSS-REFERENCE TO RELATED PATENT APPLICATION

This application claims the benefit of Korean Patent Application No. 10-2007-0118518, filed on Nov. 20, 2007 in the Korean Intellectual Property Office, the entire contents of which is incorporated herein by reference.

### BACKGROUND OF THE INVENTION

1. Field of the Invention

The present invention relates to a method of providing an automatic sorting packing service and a kiosk providing the automatic sorting packing service. More particularly, the present invention relates to a method of providing an automatic sorting packing service that sorts photo images according to characters in photo images, where the service relates to printing of photos, and a kiosk providing the automatic sorting packing service.

2. Description of the Related Art

Kiosks, while are also referred to as unattended automatic terminals, are computer terminals that are usually provided in public places such as schools, banks, airports, hotels, malls and the like. These kiosks allow users to access information such as travel information. They also provide users with the ability to automatically process exclusive affairs. Conventional kiosks have been mainly used to deliver standardized information that is stored in systems, such as for providing information on how to make use of, and how to locate, public places, and the like. In view of this, such conventional kiosks have limited applications associated with them and they have provided users with relatively low value-added services in view of the associated general costs incurred in installing such kiosks.

On the other hand, owing to the rapid growth of digital cameras and camera-embedded mobile devices, for example, businesses and services relating to the printing of digital images have developed in recent times. In this regard, photo printers for printing photo images have been commercialized by applying inkjet, dye sublimation transfer, and direct thermal printing methods, for example. In view of general costs incurred in purchasing and managing photo printers, digital photo printing studios receive printing orders on-line or off-line from clients and provide such clients with services for printing photo images.

However, conventional photo printing services require clients or printing service providers to identify characters of photo images personally, to determine the number of prints of images, and to manually sort printed photos according to characters contained therein if such sorting is desired by the clients. Since conventional unattended photo printing services have a very low automation rate, a technical means for completely automating unattended photo printing services is needed.

### SUMMARY OF THE INVENTION

The present invention provides an automatic sorting packing service identifying characters appearing in photos and automatically sorting photos containing each character. This is achieved by applying an image processing technology to photo images that are to be printed according to a client's order. As a result, this makes it possible to completely automate an unattended photo printing service, and also to extend a kiosk's application from merely a simple guide service to a high value-added service including automatic sorting of photos.

According to an embodiment of the present invention, a method of providing an automatic sorting packing service sorting photo images according to characters included in the photo images is disclosed. This method includes: extracting a characteristic of each character from a face area of each photo image for which printing has been requested; determining whether a detected character is a new character by comparing the extracted characteristic with a characteristic stored in a database; if the detected character is determined to be a new character, storing the extracted characteristic in the database, allocating a new packing line to the detected character, and adding a corresponding photo image to the allocated packing line; and if the detected character is determined to be a character that has previously been recorded in the database, adding the corresponding photo image to the packing line of the detected character.

The extracting, determining, storing, and adding processes may be repeatedly performed for each of the photo images to be printed.

In the extracting of the characteristic, when a plurality of characters are found in the same photo image, the determining, storing, and adding processes are repeatedly performed for each character.

The packing line may be realized as a buffer memory that is a storage space allocated to each character, wherein, in the adding of the corresponding photo image, an ID of the photo image is stored in the packing line.

The ID of a photo image may be an ID number allocated to the each photo image or a file name of the each photo image.

The method may further include, after adding corresponding photo image, printing photo images with IDs included in a packing line of each character.

The packing lines may be realized as receipt trays that are spaced apart from each other, as output locations allocated to characters, in order to spatially divide output photo prints that are to be distributed to each character.

In the adding of corresponding photo image, a corresponding photo image may be printed to a receipt tray allocated to the character.

According to another embodiment of the present invention, a method of providing an automatic sorting packing service sorting photo images according to characters included in the photo images is disclosed. This method includes: recognizing characters from each of the photo images for which printing is requested; preparing a data table in such a way as to retain the association between the photo images and characters thereof; and allocating a packing line to a character that is to be printed, and adding an ID of a photo image capturing the character that is to be printed in corresponding packing line based on the data table.

The packing line may be realized as a buffer memory that is a storage space allocated to each character, wherein, in the allocating of the packing line, an ID of a corresponding photo image is stored in the packing line.

The method may further include, after allocating the packing line, printing photo images with IDs stored in a packing line of each character.

The packing lines may be realized as receipt trays that are spaced apart from each other, as output locations allocated to characters, in order to spatially divide output photo prints that are to be distributed to each character.

In the adding a photo image, a corresponding photo image may be printed to a receipt tray allocated to the character.

The method may further include, after preparing the data table, guiding a user's selection of characters that are to be printed or that are not to be printed.

According to another embodiment of the present invention, a method of providing an automatic sorting packing service sorting photo images according to characters included in the photo images is disclosed. This method includes: extracting characteristic of each character from photo images for which printing is requested; determining whether a detected character is to be printed based on the extracted characteristic; if it is determined that the detected character is to be printed, storing an ID of a corresponding photo image in a packing line allocated to the detected character; and printing photo images with the IDs stored in a packing line of each character.

The method may further include, after extracting the characteristic, displaying photo images of characters that are detected in the photo images for which printing has been requested, and guiding a user's input of characters that are to be printed or that are not to be printed.

The method may further include, after extracting the characteristic, displaying photo images of characters that are detected in the photo images for which printing is requested, and guiding a user's input for establishing a relationship between the characters.

The determining of whether the detected character is to be printed may include: determining whether the detected character belongs to a group for which a relationship has been established by the user; if the detected character is a character for which a relationship has been established, identifying whether an ID of a corresponding photo image is stored in a packing line of another character that is related to the detected character and belongs to the group; and if the detected character is not a character for which a relationship has been established, or although the detected character is the character for which relationship is established, if the ID of the corresponding photo image is not stored in the packing line of another character that is related to the detected character, determining the detected character is to be printed.

According to another embodiment of the present invention, a kiosk providing an automatic sorting packing service sorting according to characters is disclosed. The kiosk includes: a face recognizing unit searching for a face area of a photo image, for which printing is requested, and extracting a characteristic from the face area; and a controller determining whether a detected character is a new character by comparing the extracted characteristic with a characteristic stored in a database. If the detected character is determined to be a new character, the extracted characteristic will be stored in the database and a new packing line will be allocated to the detected character. A corresponding photo image in the allocated packing line will be added. If the detected character is determined to be a character that has previously been recorded in the database, the corresponding photo image will be added to the packing line of the detected character.

The packing line may be realized as a buffer memory that is a storage space allocated to each character, wherein the controller stores an ID of a corresponding photo image in the packing line.

The kiosk may further include: a printing unit printing photo images with IDs based on a buffer memory allocated to each character.

The packing lines may be realized as receipt trays that are spaced apart from each other, as output locations allocated to characters, in order to spatially divide output photo prints that are to be distributed to each character.

The controller may operate a printing unit to print a corresponding photo image to a receipt tray allocated to the character.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an example of a kiosk providing an automatic sorting packing service sorting photo images according to characters in photo images, according to an embodiment of the present invention;

FIG. 2 is a diagram of an example of the appearance of a kiosk according to an embodiment of the present invention;

FIGS. 3A and 3B are flowcharts illustrating an example of a method of providing a packing service according to an embodiment of the present invention;

FIGS. 4A and 4B are flowcharts illustrating an example of a method of providing a packing service according to another embodiment of the present invention;

FIGS. 5A and 5B are flowcharts illustrating an example of a method of providing a packing service according to another embodiment of the present invention;

FIGS. 5A and 5C are flowcharts illustrating an example of a modification of the method of providing the packing service of FIGS. 5A and 5B;

FIGS. 6A and 6B are flowcharts illustrating an example of a method of providing a packing service according to another embodiment of the present invention; and

FIGS. 7A and 7B are flowcharts illustrating an example of a method of providing a packing service according to another embodiment of the present invention.

### DETAILED DESCRIPTION OF THE INVENTION

Hereinafter, a method of providing an automatic sorting packing service sorting photo images according to characters in photo images, where the service relates to printing of photos, and a kiosk providing the automatic sorting packing service according to the present invention will be described in detail by explaining embodiments of the invention with reference to the accompanying drawings.

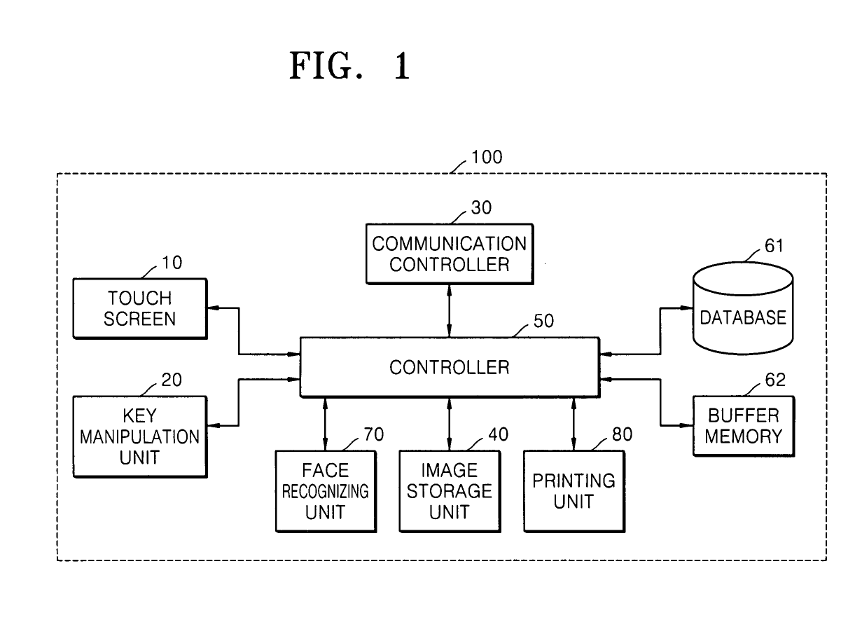

FIG. 1 is a block diagram of an example of a kiosk 100 providing an automatic sorting packing service sorting photo images according to characters in photo images, according to an embodiment of the present invention. Referring to FIG. 1, the kiosk 100 includes, for example, a touch screen 10 providing a graphic-type user interface, a communication controller 30 initializing and controlling an image transmission path, an image storage unit 40 temporally storing transmitted photo images, a face recognizing unit 70 analyzing a digital signal of photo images, detecting a face area, and determining a characteristic amount of each character, a database 61 storing the characteristic amounts extracted from the face recognizing unit 70 as an ID of a character, a buffer memory 62 storing ID numbers of photo images to be printed for each character, a printing unit 80 printing photo images having IDs stored in the buffer memory 62 on print sheets, and a controller 50 functioning as a CPU and generally controlling each operational state of the above elements and data flow there between.

The touch screen 10 displays general information on photo printing and various types of menu screens and guides a user's selection of an option. The touch screen 10 may function as a user input unit. In addition to or replacement of the touch screen 10, the kiosk 100 can further comprise a key manipulation unit 20 as the user input unit. When the key manipulation unit 20 replaces the touch screen 10, the touch screen 10 can be a general-purpose screen dedicated to displaying the general information and menu screens. The key manipulation unit 20 can include a plurality of manipulation keys including a selection-confirmation key used to select a menu item pointed to by a cursor or an activated cursor. A user's manipulation detected by the touch screen 10 and/or the key manipulation unit 20 is converted into a corresponding input signal and is transmitted to the controller 50.

The communication controller 30 provides, for example, a USB port, a card reader port, etc., used to connect a portable detachable memory device carried by the user. When the communication controller 30 is connected over a wired or wireless communication network including the Internet, for example, the communication controller 30 may be connected to a specific Web server, initialize a communication setting, and control transmission of photo images. The image storage unit 40 stores the photo images transmitted through the communication controller 30 and can be realized as a temporal storage device such as, for example, DRAM, and the like.

The face recognizing unit 70 uses a face recognition algorithm to perform a first process for detecting a face area, which is an area containing a captured human face, and a second process for determining the characteristic amount of a character from the detected face area. In the first process, the face recognizing unit 70 detects edge information (for example, contours) from a distribution of a brightness signal presented on the photo images, and identifies the face area, according to whether the elements of the face such as the contours, eyes, nose, mouth, etc. are detected, by comparing with a configurative model. In the subsequent second process, the face recognizing unit 70 determines a unique characteristic amount of the detected face area as identification information of captured characters. For example, the characteristic amount can be a quantity, face brightness information, face color information or the like that are obtained by converting part of the elements of the face such as the eyes or nose mathematically.

The face recognizing unit 70 can perform preprocessing in order to increase a recognition rate and promote efficiency of the first and second processes by converting the input photo images into images in which it is easier to extract a face area. In the preprocessing, the face recognizing unit 70 can apply a low frequency pass filter to the input photo images to filter out a noise component of high frequency, perform a color space conversion converting RGB color information into a YCrCb space, perform illumination compensation offsetting a difference in a face recognition rate according to a change in environment illumination, and the like. The face recognizing unit 70 can be programmed in an exclusive CPU or a CPU of the controller 50. for example.

The database 61 accumulates the characteristic amount of each character obtained by the face recognizing unit 70 and may comprise, for example, a data table so that a one-to-one correspondence of the characteristic amount with its corresponding character is retained. In this regard, the controller 50 searches for a characteristic amount in the database 61 that is the same as a characteristic amount extracted from a photo image, and if the same characteristic amount within an error range is found, determines the characters corresponding to both the extracted and found characteristic amounts to be the same.

The buffer memory 62 allocates an independent storage space to each character appearing in the photo images and accumulates ID numbers of photos capturing corresponding character in the independent storage space. The controller 50 searches the buffer memory 62 allocated to each character and prints the photo images cited by the ID numbers in order to print a complete set of photos containing a corresponding character.

The printing unit 80 prints a photo image in response to a printing command of the controller 50, and printing can be realized using various kinds of mechanisms including a thermal electronic image forming mechanism that selectively heats a development material on a print sheet and forms a predetermined image, an electro photography image forming mechanism that uses a potential difference in an electrostatic latent image formed on a photoconductive drum, or an inkjet image forming mechanism that discharges and injects ink droplets onto the print sheet.

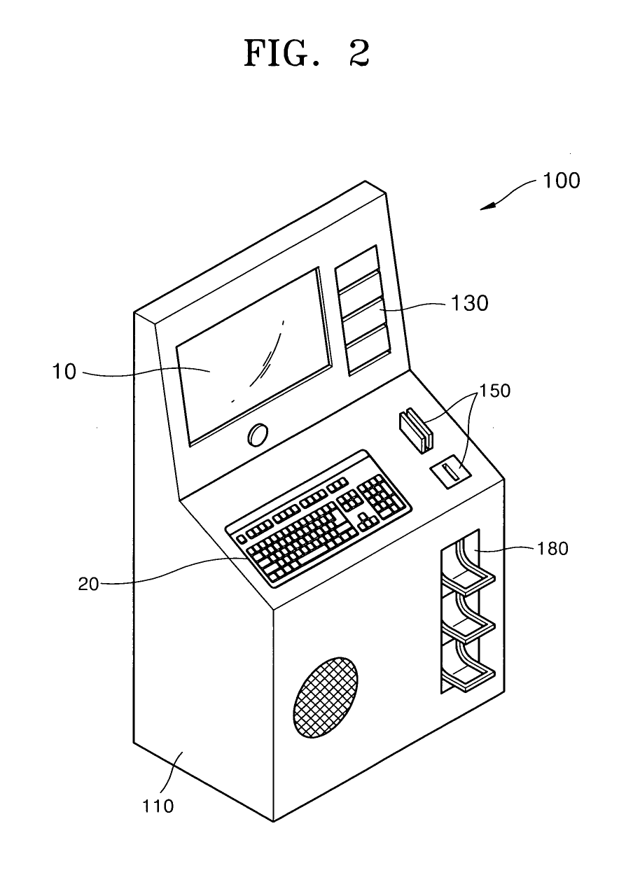

FIG. 2 is a diagram of an example of the appearance of the kiosk 100 according to an embodiment of the present invention. Referring to FIG. 2, the touch screen 10 that displays general information necessary for outputting photos is installed in a direction facing a user. A slot 130 for inputting a memory device is installed at a position adjoining the screen 10. One or more slots can be installed according to the type(s) of memory to be used with the kiosk, for example. The key manipulation unit 20, including a plurality of manipulation keys, is installed on a main body 110, that is projected, for example, in a forward direction to face a user, and is used as a user input unit that receives a user's input, like the touch screen 10. The main body 110 can include a payment means slot 150 that accepts payment. A plurality of slots corresponding to various payment means is installed, for example. Prints that are output from the kiosk are piled up on a receipt tray 180 installed in the main body 110. A plurality of receipt trays can be installed to spatially divide output prints of each character, for example. Each receipt tray 180 divides and receives output prints in this example, which circumvents the need for a user to divide the photos manually, thereby increasing a user's convenience.

Before describing a method of providing an automatic sorting packing service sorting photo images according to characters in photo images, a brief explanation of the principle of the present invention will now be provided. The packing service according to the present invention identifies characters captured in photo images and provides an output print of each photo in which the identified characters appear. Based on an identity analysis of each character, ID numbers of photo images in which the characters appear are accumulated in a buffer memory allocated to each character, and photo images with ID numbers recorded in the buffer memory are printed, thereby completing a printing job with regard to each character. For example, when characters A, B, C, and D are analyzed in a plurality of input photos #1 through #4 with ID numbers, ID numbers of photo images to be printed can be accumulated in buffer memories M(A), M(B), M(C), and M(D) that are respectively allocated to the characters A, B, C, and D according to equation 1.

M(A)={#1 ,#2}

M(B)={#2,#4}

M(C)={#1,#3}

M(D)={#3,#4} (1)

If the photos #1 through #4 are continuously printed referring to the ID numbers recorded in the buffer memories M(A), M(B), M(C), and M(D) that are respectively allocated to the characters A, B, C, and D, for example, photos corresponding to ID numbers #1 and #2 recorded in the buffer memory M(A) are printed, and thus, photos on which the character A appears are completely printed. In this regard, equation 1 shows a packing list including a photo list allocated to each character.

Hereinafter, a method of providing a packing service will be described.

### First Embodiment

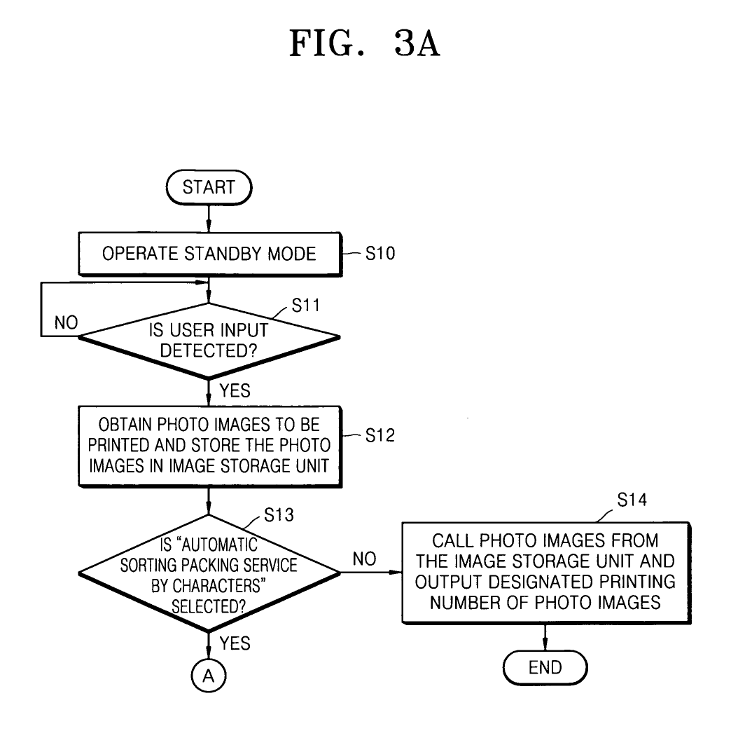

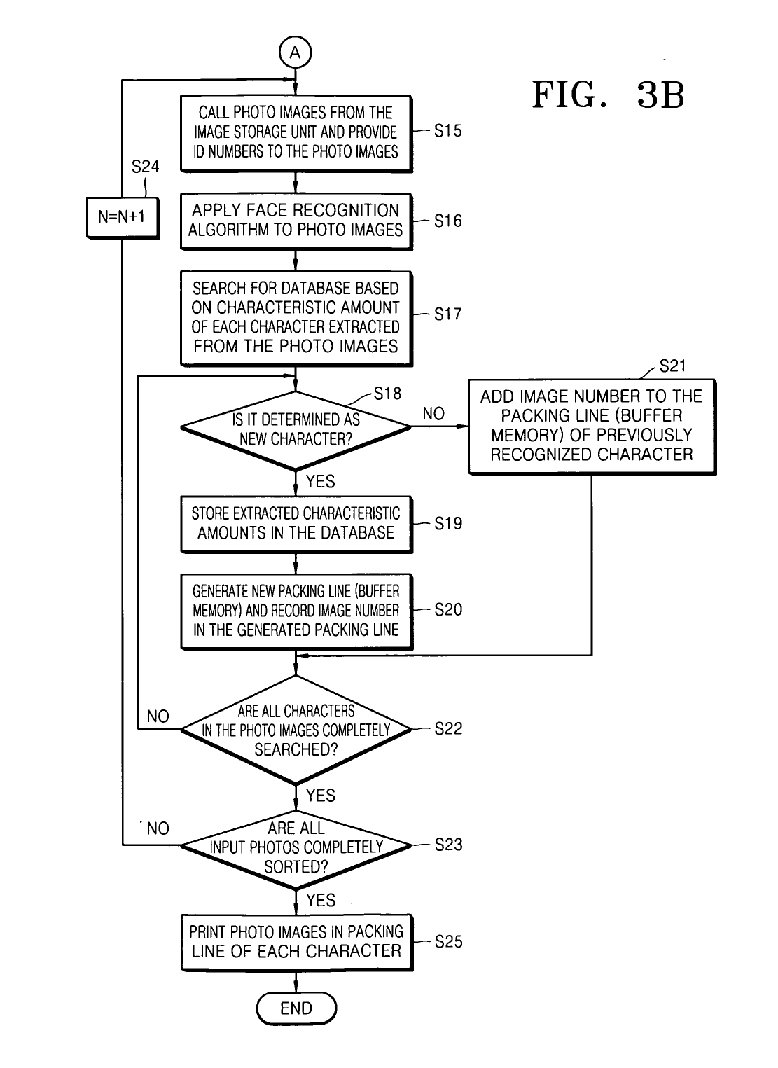

FIGS. 3A and 3B are flowcharts illustrating an example of a method of providing a packing service according to an embodiment of the present invention. In more detail, the flowcharts illustrate a method of controlling the kiosk 100 providing the packing service, and in particular, illustrate an algorithm mainly used by the controller 50.

Referring to FIG. 3A, before being accessed by a user the kiosk 100 is in an idle state, in which the kiosk 100 stands by while displaying a menu of service types offered on the touch screen 10 (operation S10). When a user's input is detected from a user input unit such as the touch screen 10 or the key manipulation unit 20 (operation S11), the controller 50 prepares to provide a service according to the user's input selection.

In more detail, if the user's input selection is determined to be a photo printing service, the controller 50 requests that the user transmit a photo image to be printed, and inputs the photo image received from the user into the image storage unit 40 (operation S12). The controller 50 can guide a user through the various options for obtaining photo images using the display menu. For example, the user can connect a portable detachable memory device carried by the user to the kiosk 100 and transmit a photo image stored in the portable detachable memory device to the kiosk 100. The user can also access a specific Web server through the kiosk 100 and download a photo image that was previously uploaded and stored by the user. Photo images that are transmitted over a wired/wireless connection or an Internet communication network are stored in the image storage unit 40 of the kiosk 100. According to embodiments of the kiosk 100, it is possible to edit the transmitted photo images. The controller 50 can inquire whether the user wishes to edit the transmitted photo images and edit them according to a user's instruction.

Thereafter, the controller 50 displays details of services related to photo printing that are offered and guides a user's selection. In particular, the controller 50 displays a selection menu requiring a YES/NO response of an offer for “an automatic sorting packing service sorting photo images according to characters in photo images” on the touch screen 10, a user's selection is input, and the user's input selection is read (operation S13). If the user's input is NO in response to the offer for the “automatic sorting packing service sorting photo images according to characters in photo images,” photo images stored in the image storage unit 40 are printed according to operations after operation S14. In particular, a specific number of printing sheets of overall photos in a package is designated according to a user's instruction, or a different number of printing sheets of each photo is designated according to a user's respective reference result (operation S14).

If the user's input is YES in response to the offer for the “automatic sorting packing service sorting photo images according to characters in photo images,” an automatic sorting process is performed according to operations subsequent to operation S13. One by one, the controller 50 calls M photo images recorded in the image storage unit 40 in an optional calling order and repeatedly performs a series of sub routines S15-S24 that are to be described later with regard to each photo image. A packing list per character is updated in each sub routine by recording a current input image in the buffer memory 62 allocated to characters. After an input photo image has been processed, a subsequent photo image that has not yet been processed may be called and processed. The packing list is completed in the M^{th} sub routine in which the final (M^{th}) photo image in the image storage unit 40 is completely processed.

The controller 50 starts the automatic sorting sub routines S15-S24 by, for example, allocating unique ID numbers #N to the input photo images according to the order in which they were called (operation S15). Subsequently, a photo image can be referred to by an ID number #N allocated thereto. Alternatively, a photo image can be referred by a file name of the input photo image without allocating ID number thereto. The controller 50 uses the face recognition algorithm to analyze the input photo images (operation S16), and extracts identifiable characterizing elements of each character appearing in photos. For example, in a face recognition algorithm, the controller 50 performs a series of preprocessing steps to increase a recognition rate including high frequency filtering to remove a noise component of the called photo image, compares edge information (contours) extracted from the preprocessed photo image with a configurative model, and detects a face area capturing a face of a character by recognizing the elements of the face such as, for example, the eyes, nose, mouth, or the like.

Thereafter, a characteristic amount with regards to the detected face area is determined. The characteristic amount represents a unique appearance of each character and may be selected as a parameter identifying each character from a group of persons, for example, a quantifiable geometrical characteristic of a face element, such as the eyes or nose, or face brightness information, face color information, and the like.

Meanwhile, when the series of sub routines S15-S24 are applied in advance to previously called photo images, the characteristic amounts extracted from the photo images are accumulated in the database 61. The characteristic amounts may be stored in a table format in such a way as to retain their associations with their corresponding characters. The controller 50 compares a currently calculated characteristic amount of a character with a plurality of pieces of data stored in the database 61 (operation S17). If the controller 50 detects a value identical/similar to the currently calculated characteristic amount within the database 61, the controller 50 determines that the character is a specific character that has already been recognized in a previous stage, and, alternatively, if the controller 50 fails to detect a value identical/similar to the currently calculated characteristic amount within the database 61, the controller 50 determines that the character is newly recognized in a current stage (operation S18). When the character is newly recognized, the characteristic amount extracted from the newly recognized character is accumulated in the database 61 (operation S19) as an ID of the character, making it possible to recognize the character when he/she appears in other photo images as the same character. The controller 50 generates a buffer memory 62 which is allocated to the character and records an ID number #N corresponding to a current photo in the buffer memory 62 (operation S20). Alternatively, when the character has already been recognized, the controller 50 additionally records an ID number #N in the buffer memory 62 corresponding to the photo image (operation S21). The controller 50 determines whether all detected characters in the input photo images are completely processed (operation S22). That is, when a plurality of characters are detected in input photos, operations subsequent to operation 18 are repeatedly performed to sort the plurality of characters.

As an example of the above-described process performed by the controller 50, when three characters A, B, and C appear on photo images, the controller 50 extracts a characteristic amount of each character, refers to the database 61, determines the characters A and B to be previously recognized characters based on a similarity between the extracted characteristic amounts and data stored in the database 61, and determines the character C to be a newly recognized character. The controller 50 completely processes the previously recognized characters A and B by additionally recording an ID number #N of a current photo image in buffer memories M(A)={. . . ,#N} and M(B)={. . . ,#N} allocated to the characters A and B, respectively, generates a buffer memory M(C) allocated to the newly recognized character C, and stores an ID number #N of the photo image in the buffer memory M(C) (M(C)={#N}). ID numbers of photos containing characters are accumulated in a buffer memory allocated to each character as the photo image processing progresses. The printing unit 80 prints photo images of each character based on a list of photos obtained from each buffer memory.

If the automatic sorting process sorting photo images according to characters contained therein is complete, the controller 50 determines whether there is an unprocessed photo image remaining by referring to the image storing unit 40 (operation S23), and, according to the reference result, may call an unprocessed photo image, and start the automatic sorting process of sub routines S15-S24 in order to continue the photo image sorting process. In operation S24, a photo image may be allocated an ID number N, and the next photo image called may be allocated an ID number N+1, and in general, ID numbers allocated to sequentially called photo images are increased by one relative to the ID number of the previously called photo image).

Meanwhile, if the image storing unit 40 does not store an unprocessed photo image, the controller 50 determines that the automatic sorting process with regard to all photo images is completed, and starts the printing job (operation S25). As shown in equation 1, the controller 50 generates printing data with regard to the photo images indicated by ID numbers in packing lists, listing photos sorted according to characters contained therein, and performs a printing job to generate packages of the photos sorted according to each character by driving the printing unit 80. The printing unit 80 may make a single pile of output prints, ensuring, however, that each set of output prints of a particular packing list are grouped together within the pile so that the user does not need to do an additional distribution operation. In this regard, output photos can be piled up on the receipt tray 180 installed in the kiosk 100. Alternatively, a plurality of receipt trays 180 can be installed at different levels according to a shape of the kiosk 100, and output photos that are to be separated according to different characters are piled up on the receipt trays 180 so that output photos for each character can automatically be spatially divided.

### Second Embodiment

In the present embodiment, a separate receipt tray is respectively allocated for each character appearing in input photos, a specific character is analyzed in a photo image, and simultaneously the photo image is output to the receipt tray allocated to the analyzed character. For example, when characters A, B, C, and D are analyzed in a plurality of input photos #1 through #4, printed photos are output to and accumulated in receipt trays T(A), T(B), T(C), and T(D) allocated to the characters A, B, C, and D, respectively below.

T(A)={#1 ,#2}

T(B)={#2,#4}

T(C)={#1,#3}

T(D)={#3,#4} (2)

The photos #1 through #4 that are sorted according to the characters A, B, C, and D are accumulated in the receipt trays T(A), T(B), T(C), and T(D), respectively. Equation 2 shows a packing list of photos sorted according to the characters A, B, C, and D.

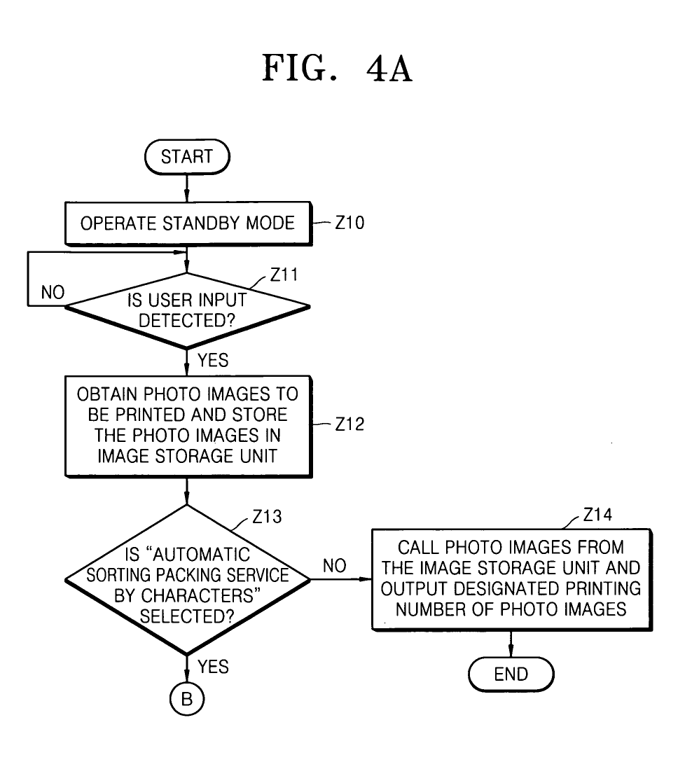

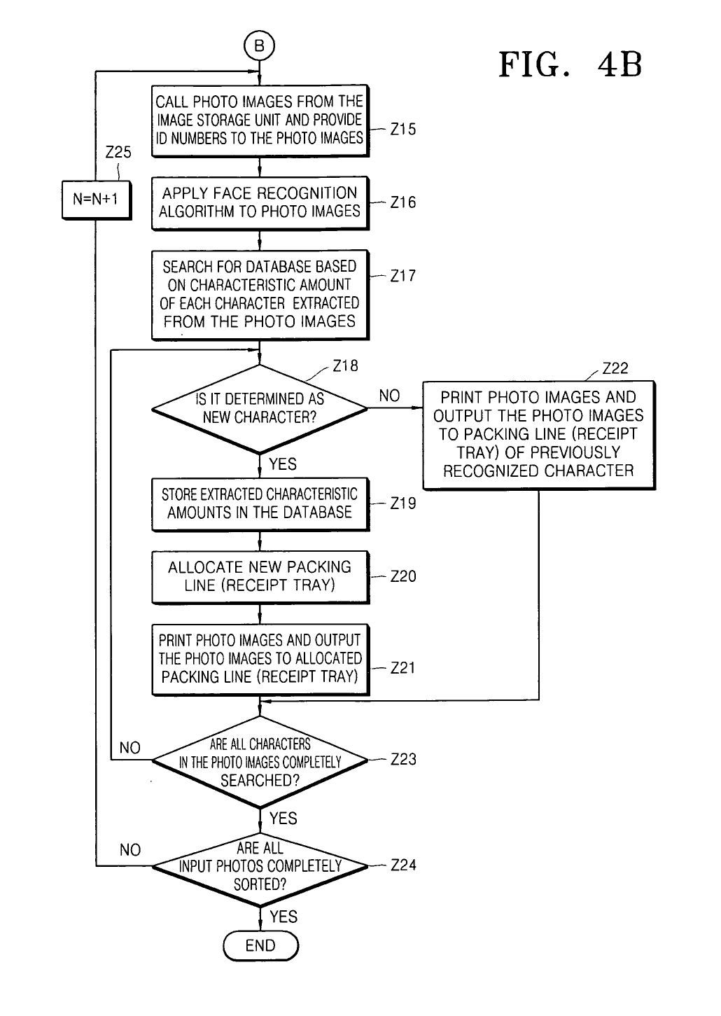

FIGS. 4A and 4B are flowcharts illustrating an example of a method of providing a packing service by controlling the kiosk 100 according to another embodiment of the present invention. In the present embodiment, technical matters that are different from those of the previous embodiment with reference to FIGS. 3A and 3B will now be described.

If the controller 50 that operates in a standby mode (operation Z10) detects user access through the touch screen 10 (operation Z11), the controller 50 is activated and exits the standby mode, and carries out a general procedure for providing a photo output service according to a user's input. In more detail, the controller 50 requests that a user transmit photo images that are to be printed, and stores the photo images, received through a communication network like the Internet or an input port like a USB, in the image storage unit 40 (operation Z12).

The controller 50 displays a selection menu requiring a YES/NO response to an offer for an “automatic sorting packing service sorting photo images according to characters in photo images” on the touch screen 10, as a service item relating to the photo output, receives a user's selection, and reads an input signal (operation Z13). If a user's input is NO in response to the offer for the “automatic sorting packing service sorting photo images according to characters in photo images,” the controller 50 performs a print job (operation Z14). Meanwhile, if the user's input is YES in response to the offer for the “automatic sorting packing service sorting photo images according to characters in photo images,” the controller 50 calls the photo images recorded in the image storage unit 40 one by one in an optional order and repeatedly performs a series of automatic sorting sub routines Z15 through Z25 with regard to each photo image. In more detail, in each sub routine Z15 through Z25, unique ID numbers #N are provided to called photos (operation Z15), face areas are detected in the called photos by using the face recognition algorithm (operation Z16), and a characteristic amount extracted from a detected face area is searched for in the database 61 (operation Z17). The database 61 stores data such that the associations between characteristic amounts extracted from photo images processed up to a current stage and the corresponding characters are retained.

As a result of the search, the controller 50 determines whether the character in the face area is a new character (operation Z18). If it is determined to be a new character, the controller 50 records the characteristic amount extracted from the new character in the database 61 (operation Z19), while allocating an additional receipt tray to the character (operation Z20), carries out a print job and outputs photo images to the receipt tray allocated to the corresponding character (operation Z21). Alternatively, if it is determined to be a previously recognized character, the controller 50 outputs photo images to a receipt tray allocated to the previously recognized character (operation Z22). Although not shown, a photo image can be guided to a desired receipt tray by turning an output end of a guide rail disposed inside the kiosk 100 and changing an output path to guide a photo printout to a desired receipt tray among a plurality of receipt trays. Thereafter, the controller 50 determines whether all detected characters in the input photo images are completely processed (operation Z23). That is, if two or more characters are detected in a current photo, the same process is repeated for the other character(s).

With regard to the process carried out by the controller 50, when characters A, B, C, and D appear in a photo image, the controller 50 extracts a characteristic amount from each character and searches for the characteristic amount in the database 61. As an example, the controller 50 may determine that the characters A and B have been previously recognized by comparing the extracted characteristic amount and a characteristic amount stored in the database 61, and determine that the character C is a newly recognized person. Then, the controller 50 outputs photo prints to receipt trays T(A) and T(B) allocated to the previously recognized characters A and B. The controller 50 allocates an additional receipt tray T(C) to the newly recognized character C and outputs the photo print to the receipt tray T(C). In the present embodiment, a print job is carried out whenever a character is detected in each photo, which is different to the previous embodiment, with reference to FIGS. 3A and 3B, in which all photo images are analyzed and then photos sorted according to characters are printed at one time.

On the other hand, if the called photo images are completely processed, the controller 50 searches the image storage unit 40 and determines whether there is a photo image that has not been processed (operation Z24), prepares new ID numbers if there are unprocessed photo images (operation Z25), calls the unprocessed photo images, and repeatedly performs operations Z15 through Z25. Meanwhile, if there is no photo image that has not been processed, the controller 50 determines that all photo images are completely processed and ends the procedure.

### Third Embodiment

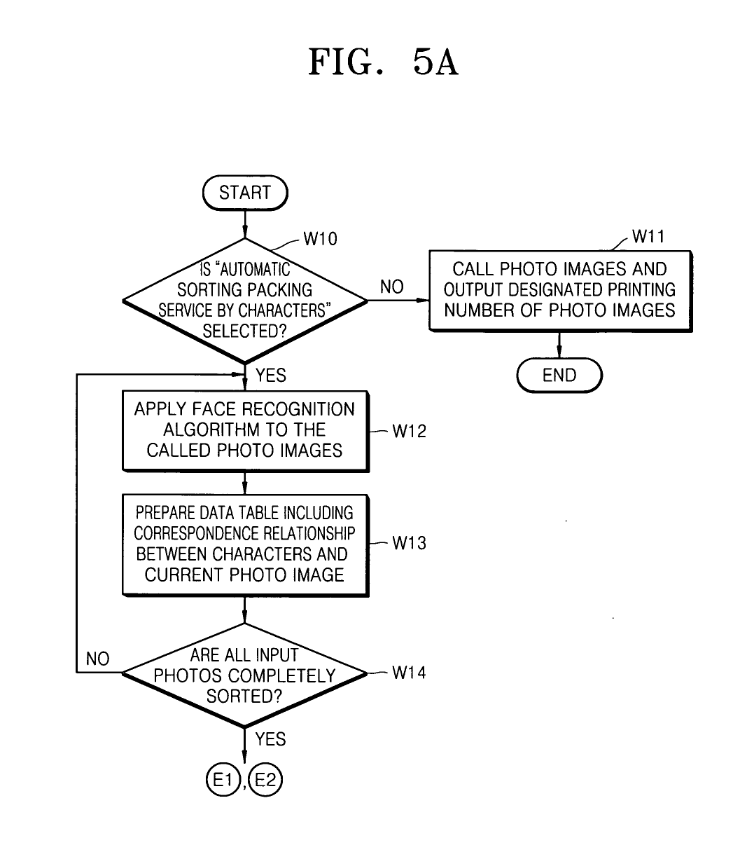

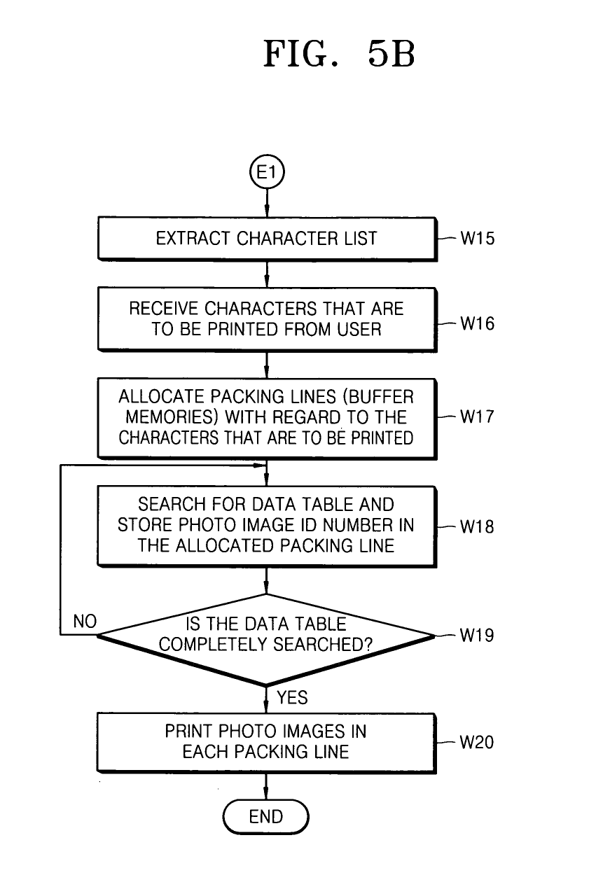

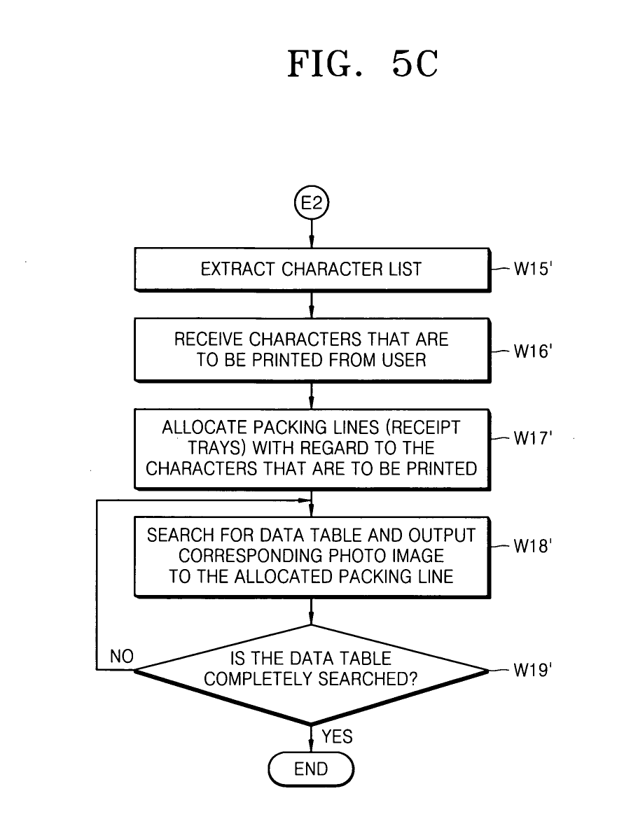

FIGS. 5A and 5B are flowcharts illustrating an example of a method of providing a packing service according to another embodiment of the present invention. Referring to FIG. 5A, the controller 50 inquires of the user whether to start an automatic sorting packing service sorting photos that are input from a user according to characters (operation W10), and proceeds with a photo print job following a general procedure (operation W11) according to a user's input. For example, the controller 50 can output a predetermined print number of the input photos that is designated by the user. Alternatively, the controller 50 can proceed with the automatic sorting packing service sorting photos according to characters contained therein in operations subsequent to operation W10. The automatic sorting packing service sorting photos according to characters contained therein starts by calling a plurality of photos, stored at a location designated by the user, one by one in an optional order, using the face recognition algorithm (operation W12). The controller 50 recognizes characters appearing on each photo image and prepares a data table retaining associations between characters and the photo images in which they appear (operation W13). For example, when characters A and B are searched for in a photo with a unique ID number #1, the characters A and B are associated with the ID number #1. When characters A, B, C, and D are searched for in photos with ID numbers #1, #2, #3, and #4, the data table below may be prepared.

TABLE 1

| Photo Image ID Numbers | Characters |
|---|---|
| #1 | A, B |
| #2 | B, C |
| #3 | A |
| #4 | A, B, C |

Next, if the controller 50 determines that the input photos are completely sorted (operation W14), the controller 50 extracts and displays a character list (operation W15), and receives a selection of characters to be printed from the user (operation W16). For example, the controller 50 displays a list of the characters A, B, C, and D shown in the data table (Table 1), for the benefit of the user on the touch screen 10 and requests that the user make a selection of characters that are to be printed or not printed.

The controller 50 allocates a buffer memory to each character which has been selected for printing (operation W17). When printing of the characters A and C has been selected, the controller 50 generates buffer memories M(A) and M(C), searches for the data table (Table 1), and stores photo image ID numbers corresponding to photos in which the characters A and B appear in the buffer memories M(A) and M(C) (operation W18). For example, the controller 50 searches for lines corresponding to the photo image ID numbers #1 through #4 one by one to determine whether the characters A and C are included in the photo images with ID numbers #1 through #4, stores the photo image ID numbers associated with the characters A and C in the buffer memories M(A) and M(C), and completes a packing according to equation 3 below.

M(A)={#1,#3,#4}

M(C)={#2,#4} (3)

If the controller 50 has completely searched the data table (operation W19), the controller 50 proceeds with a print job based on the photo image ID numbers recorded in each packing line (operation W20). In more detail, the controller 50 continuously outputs photos corresponding to the photo image ID numbers #1, #3, and #4 recorded in the buffer memory M(A), and then continuously outputs photos corresponding to the photo image ID numbers #2 and #4.

FIGS. 5A and 5C are flowcharts illustrating an example of a modification of the method of providing the packing service of FIGS. 5A and 5B. The operations illustrated in FIG. 5A are described above and thus their description will not now be repeated. Operations from operation W15′ illustrated in FIG. 5C will now be described. The controller extracts a list of all characters A, B, C, and D from the data table (Table 1) (operation W15′), displays the list on the touch screen 10, and receives input regarding characters that are to be printed (or are not to be printed) from a user (operation W16′). The controller 50 allocates receipt trays T(A) and T(C) to the characters A and C that are to be printed (operation W17′), searches lines corresponding to photo image ID numbers #1 through #4 in the data table (Table 1), and outputs photo images to the receipt trays T(A) and T(C) whenever the characters A and C that are to be printed are detected in the lines (operation W18′). If a determination is made that the controller 50 has completely searched the data table (operation W19′), printed photos are accumulated in the receipt trays T(A) and T(C) allocated to the characters A and C according to equation 4 below.

T(A)={#1,#3,#4}

T(C)={#2,#4} (4)

Meanwhile, the data table (Table 1) can be prepared through the operations illustrated in FIG. 5A irrespective of a user's printing request. For example, the controller 50 can prepare a character list by applying the face recognition algorithm to photos without the user's printing request, proceed with the operations illustrated in FIG. 5B or 5C in response to the user's printing request after a period of time, and complete a print job. For example, the controller 50 stores a data table storing characters from images uploaded over the Web, as additional information, and proceeds with a print job using the data table in response to a printing request from a local area. In this regard, the method of providing the packing service can comprise a combination of two or more operations that are temporally divided rather than a temporally continuous single operation.

### Fourth Embodiment

In the present embodiment, not all characters appearing on photos are printed in a package but some characters selected by the user are printed if a “character selection mode” in which a user may select the characters that are not to be printed is entered. The characters selected by the user may be designated as characters to be printed or not to be printed, and the designation is determined by which is more convenient for the user with regard to key manipulation. Generally, an easier key manipulation will be selected.

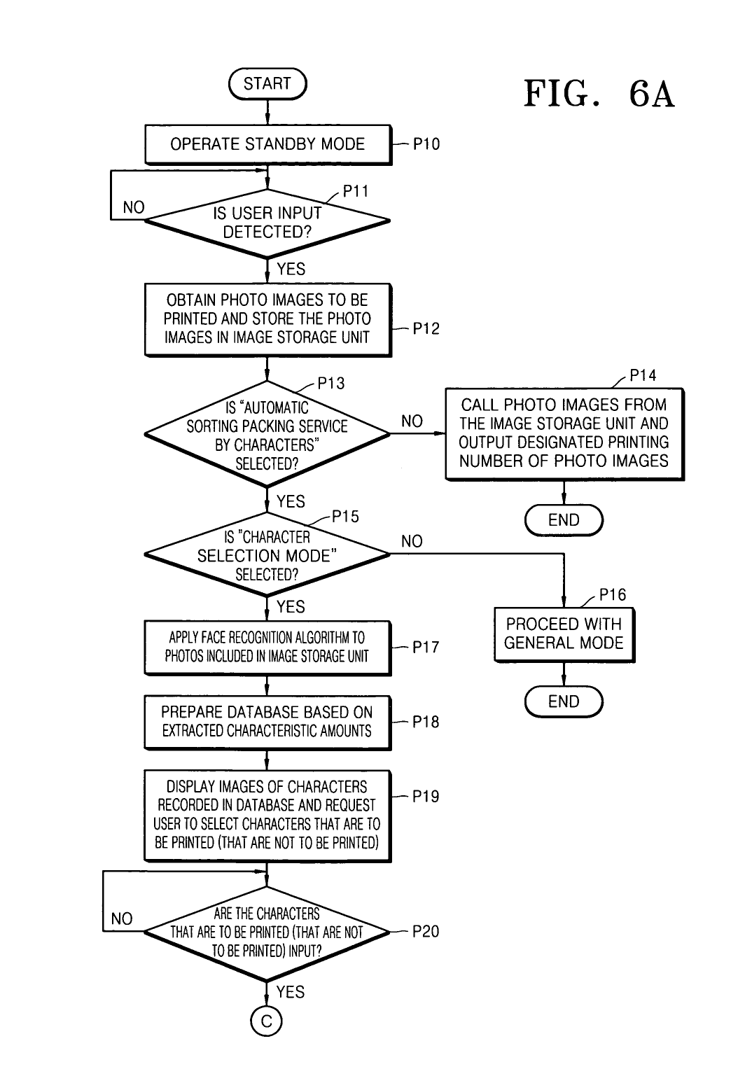

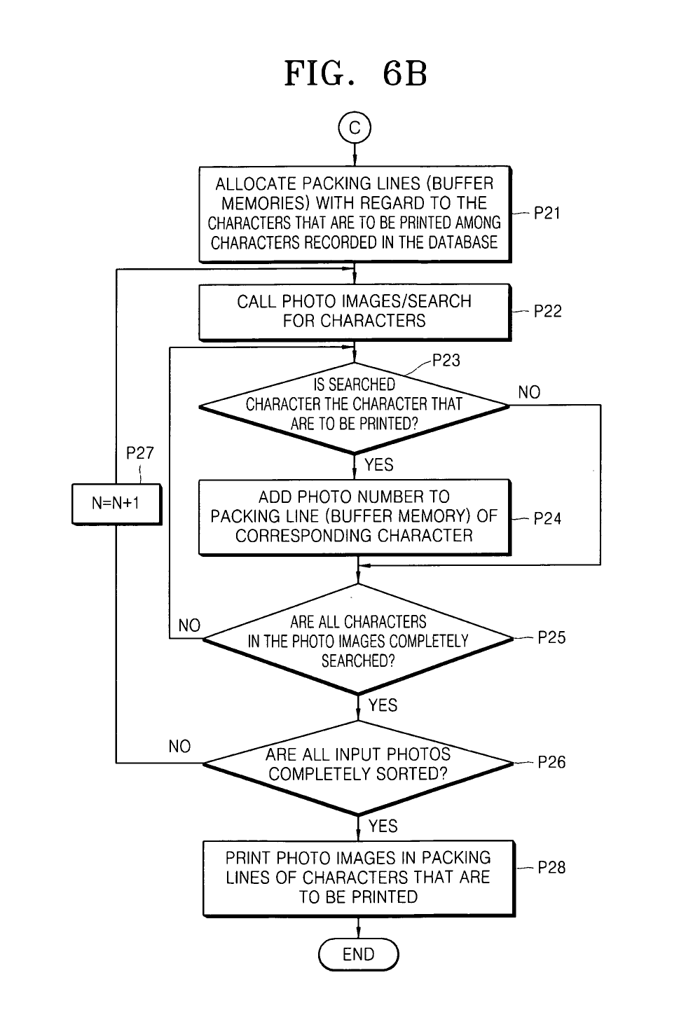

FIGS. 6A and 6B are flowcharts illustrating an example of a method of providing a packing service by controlling the kiosk 100 according to another embodiment of the present invention. In the present embodiment, technical matters that are different from those of the embodiment described with reference to FIGS. 3A and 3B will now be described.

Referring to FIG. 6A, the controller 50 that operates in a standby mode and displays a menu on the touch screen 10 (operation P10) and detects a user's input, i.e., contact with the touch screen 10 (operation P11), the controller 50 is activated when the user's input is detected and proceeds with a general procedure for providing a photo printing service according to the contact signal. In more detail, the controller 50 requests that a user transmit photo images that are to be printed, and stores the photo images transmitted over a communication network, like the Internet, or an input port, like a USB, in the image storage unit 40 (operation P12).

The controller 50 displays a selection menu requiring a YES/NO response to an offer for the “automatic sorting packing service sorting photo images according to characters” on the touch screen 10, as a detailed service item relating to photo output, receives a user's selection, and reads a user's input selection (operation P13). If the user's input is NO in response to the offer for the “automatic sorting packing service sorting photo images according to characters,” a printing job is performed according to operations after operation P14. If the user's input is YES in response to the offer for the “automatic sorting packing service sorting photo images according to characters contained therein,” the controller 50 displays the YES/NO selection menu of the “character selection mode” on the touch screen 10 as a detailed service item belonging to the automatic sorting packing service sorting according to characters, requests a user's selection, and reads a user's input selection (operation P15). If the user's input selection is NO, the controller 50 performs a package print job according to a general process described with reference to FIGS. 3A and 3B (operation P16). Alternatively, if the user's input selection is YES, the controller 50 enters the character selection mode, analyzes characters by using the face recognition algorithm on input photos (operation P17), and builds the database 61 storing characteristic amounts extracted from the characters (operation P18). In more detail, the controller 50 detects face areas from digital image signals of the input photos, extracts characteristic amounts from the detected face areas, and builds the database 61 in such a way as to retain the associations between the characters and their characteristic amounts. The controller 50 determines characters having identical/similar characteristic amounts extracted from different photos to be the same characters and unites data. The characters stored in the database 61 are sorted into ones that are to be printed and ones that are not to be printed. For example, the controller 50 displays face areas of the characters stored in the database 61 on the touch screen 10 at a reduced size (operation P19), so that the user can identify a specific character using the image and a character that is to be printed or is not to be printed is selected by the user. For example, the user may identify characters A, B, C, and D using the reduced images displayed on the touch screen 10, select a reduced image of the character C by moving an activated cursor, thus designating that the character C is not to be printed or is to be printed.

If the controller 50 detects a user's input regarding a selection of characters that are to be printed (operation P20), the controller 50 selectively allocates the buffer memory 62 to the characters that are to be printed (operation P21). The controller 50 calls photos from the image storage unit 40 one by one, provides ID numbers to the photos, and searches for characters in the photos (operation P22). The controller 50 determines that searched characters are to be printed (operation P23), accumulates the corresponding photo ID number #N in the buffer memory 62 allocated to the user selected character (operation P24). Meanwhile, the controller 50 determines the searched characters that are not to be printed, and skips those searched characters without performing an additional process. Next, the controller 50 determines whether all characters detected in the input photos are completely processed (operation P25). That is, if two or more characters are detected in a currently called photo, the operations subsequent to operation P23 are repeatedly performed for the detected characters.

As an example of the above described procedure carried out by the controller 50, if it is determined that a character C is not to be printed among characters A, B, C, and D, the controller 50 allocates buffer memories M(A), M(B), and M(D) to the characters A, B, and D, respectively, analyzes photos having ID numbers #1 through #4, and accumulates ID numbers of photos on which a character appears in a corresponding buffer memory, thereby obtaining a packing list according to characters as in Table 1. However, the controller 50 does not allocate a buffer memory to the character C that is not to be printed, and disregards the character C even if the character C is detected in a current photo.

If the currently called photo image has been completely processed, the controller 50 determines whether there is an unprocessed photo image in the image storage unit 40 (operation P26), and, if an unprocessed photo image exists in the image storage unit 40, prepares a new ID number (operation P27), calls the unprocessed photo image, and repeatedly performs the operations from operation P22. If all photos stored in the image storage unit 40 are completely sorted according to the characters, the controller 50 starts a print job based on information stored in the buffer memory 62 (operation P28).

In accordance with the above description, the controller 50 directly receives a user's selection of characters that are to be printed (or are not to be printed). In addition to the user's direct input of the selection of characters that are to be printed, when a system manages groups such as, for example, family and friends, containing a plurality of characters according to a user's predetermined designation, the user can designate characters that are to be printed in a package by simply selecting a group, for example, family or friends, instead of selecting each character included in a specific group. Alternatively, if the user has previously stored characters that are to be printed or are not to be printed in the system, a selective print job can be automatically carried out without concerning a user.

### Fifth Embodiment

In the present embodiment, since a special relationship between different characters is established, a print job is not carried out for each character but one print job is carried out for two or more characters who have a particular relationship with each other. This is because it is meaningless to provide two sheets of the same photo to each of the characters that may be in the same family (for example, a married couple). This results in an advantageous conservation of printing resources and a reduction of unnecessary cost consumption. Provided that specially concerned people in a family or a married couple can share a photo, one sheet of a photo capturing at least one of specially concerned people or a photo capturing all of specially concerned people may be printed.

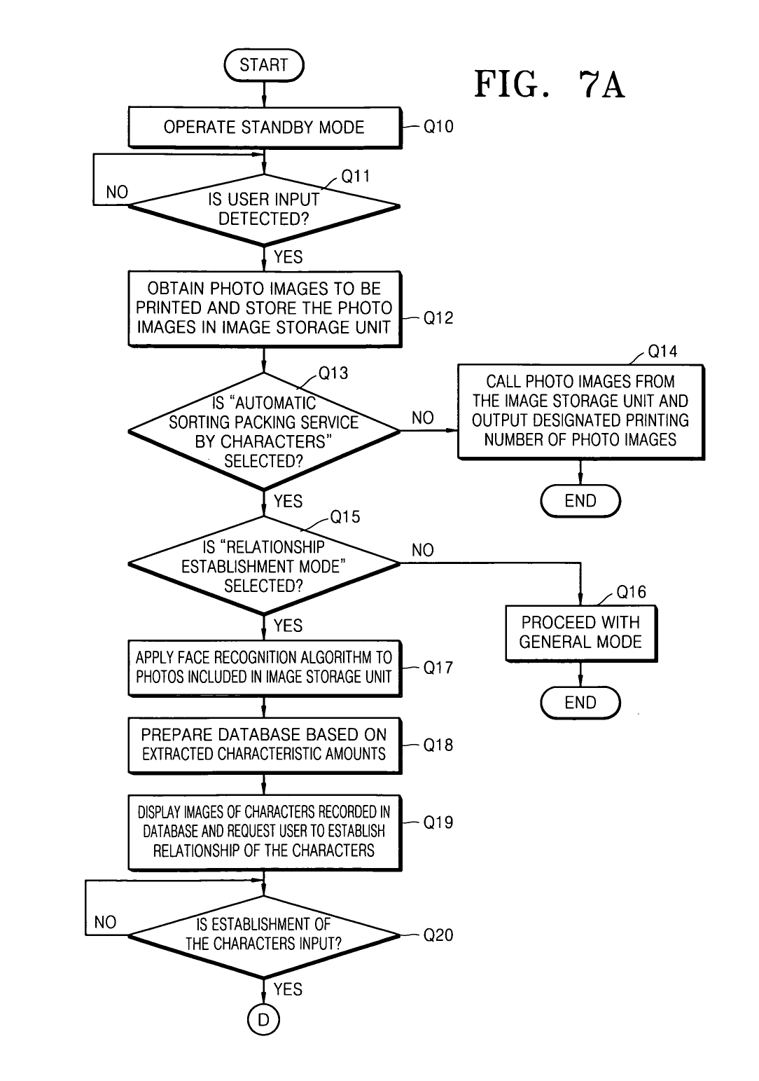

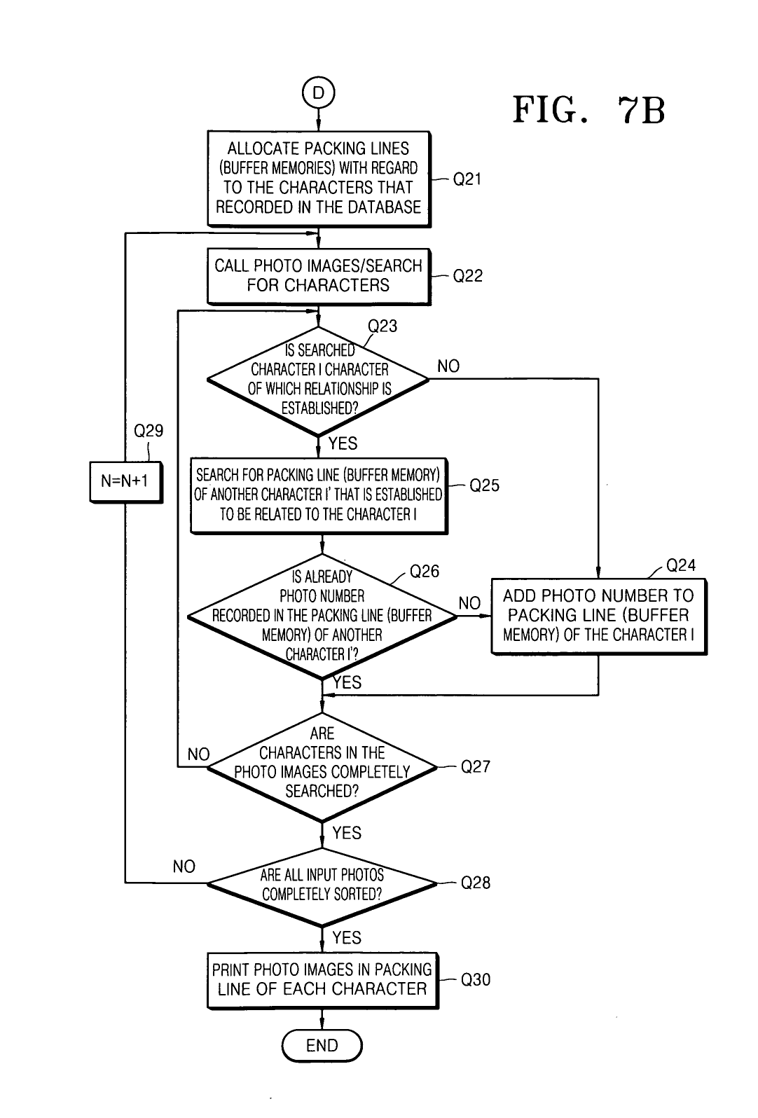

FIGS. 7A and 7B are flowcharts illustrating an example of a method of providing a packing service by controlling the kiosk 100 according to another embodiment of the present invention. In the present embodiment, technical matters that are different from those of the embodiment described with reference to FIGS. 3A and 3B will now be described.

Referring to FIG. 7A, the controller 50 firstly operates in a standby mode (operation Q10) and if access by a user is detected (operation Q11), the controller 50 is activated and exits the standby mode, and then proceeds with a general procedure for providing a photo printing service according to a user's input. In more detail, the controller 50 requests a user to transmit photo images that are to be printed, and stores the photo images transmitted over a communication network, like the Internet, or an input port, like a USB, in the image storage unit 40 (operation Q12).

The controller 50 displays a selection menu requiring a YES/NO response to an offer for an “automatic sorting packing service sorting photo images according to characters” on the touch screen 10, as a detailed service item relating to photo output, receives a user's selection, and reads a user's input selection (operation Q13). If the user's input is NO in response to the “automatic sorting packing service sorting photo images according to characters,” a printing job is performed according to operations after operation Q14. If the user's input is YES in response to the “automatic sorting packing service sorting photo images according to characters,” the controller 50 displays a YES/NO selection menu of a “relationship establishment mode” on the touch screen 10 as a detailed service item belonging to the automatic sorting packing service sorting according to characters, requesting a YES/NO response from the user as to whether he/she wishes to establish a special relationship between characters captured in photos, and reads a user's input selection (operation Q15). If the user's input selection is NO, the controller 50 performs a print job with regard to characters according to a general process described with reference to FIGS. 3A and 3B (operation Q16). Alternatively, if the user's input is YES, the controller 50 starts the relationship establishment mode according to an input signal, applies the face recognition algorithm to input photos (operation Q17), and builds the database 61 storing characteristic amounts extracted from the characters of the input photos (operation Q18).

In more detail, the controller 50 detects face areas from digital signals of the input photos, extracts characteristic amounts from the detected face areas, and builds the database 61 in such a way as to retain associations between the characters and the characteristic amounts. The controller 50 determines characters having similar characteristic amounts extracted from different photos to be the same characters and unites data. The controller 50 displays overall characters found in the database 61 that stores character information to allow the user to designate characters that are specially related. For example, the controller 50 displays face areas of the characters stored in the database 61 on the touch screen 10 as a reduced-size image, so that the user can designate a group of characters that are specially related (operation Q19). For example, the user identifies reduced-size images of characters A, B, C, and D displayed on the touch screen 10, selects a reduced-size image of the characters A and B by moving an activated cursor, and thus establishes the relationship between the characters A and B.

If the controller 50 detects a user's input selection regarding the establishment of a relationship (operation Q20), the controller 50 allocates the buffer memory 62 to each character stored in the database 61 (operation Q21), calls photos in the image storage unit 40 one by one, provides ID numbers to the photos, and searches for characters in the photos (operation Q22). The controller 50 determines if a detected character I is a specially related character (operation Q23), and performs a process which differs according to the determination. If the controller 50 determines that the character I is not a specially related character, the controller 50 adds a photo ID number to a packing line allocated to the character I and completes the process (operation Q24). If the controller 50 determines that the character I is specially related to a specific character I′, the controller 50 determines whether an ID number of the current photo has already been recorded in a buffer memory of the specially related specific character I′ (operation Q25). If the controller 50 determines that the ID number of the current photo has already been recorded in the buffer memory of the specially related specific character I′ (operation Q26), the controller 50 completes the process without recording the ID number of the current photo in the buffer memory of the character I. If the controller 50 determines that the ID number of the current photo has not been recorded in the buffer memory of the specially related specific character I′, the controller 50 adds the ID number of the current photo to the buffer memory of the character I (operation Q24). Next, the controller 50 determines whether all characters detected in the input photos are completely processed (operation Q27). That is, if two or more characters are detected in a currently called photo, the same process is repeatedly performed with regard to the detected characters.

As an example of the above procedure carried out by the controller 50, the controller 50 allocates buffer memories M(A), M(B), and M(D) to characters A, B, and D, respectively, who are identified in the database 61, analyzes photos having ID numbers #1 through #4, and accumulates ID numbers of photos in which a character appears in each buffer memory, thereby obtaining a character list including ID numbers of photos that are to be printed as in Table 1. With regard to the processing for characters having an established relationship, the controller 50 detects a character whose relationship is established from a current photo, and identifies whether an ID number of the current photo is accumulated in a buffer memory of a character that is specially related to the character. For example, provided that a relationship between characters A and B is established, and character A is detected in photo #2, if the controller 50 finds photo #2 listed in a buffer memory M(B) of character B that is specially related to character A, the controller 50 does not record photo #2 in a buffer memory of character A. However, if the controller 50 finds that photo #2 is not listed in the buffer memory M(B) of character B, the controller 50 records photo #2 in the buffer memory of character A. The above process guarantees that a photo capturing both characters A and B is not printed twice (i.e. one sheet is printed), and a single photo capturing the character A or B is printed.

If a currently called photo image is completely processed, the controller 50 determines whether there is an unprocessed photo image in the image storage unit 40 (operation Q28), prepares a new ID number according to the determination (operation Q29), calls the unprocessed photo image, and repeatedly performs operations Q22 through Q29. If all photos stored in the image storage unit 40 are completely sorted according to the characters, the controller 50 starts a print job based on ID numbers stored in the buffer memory 62 (operation Q30).

The method of providing an automatic sorting packing service sorting photo images according to characters contained therein and a kiosk providing the automatic sorting packing service sorting according to characters provide the packing service that identifies each character that appears in photos and automatically sorts photo prints that are to be output according to each character based on an image processing technology applied to photo images, thereby completely automating an unattended photo print service, which extends an application of the kiosk from a conventional simple guide service to a value-added service.

The method and the kiosk requests printing of selected specific characters by reflecting a personal favorite or necessity of a customer who requests a photo print service, or does not proceed with printing of each character if a group of characters exist that are specially related to each other according to a customer's selection but proceeds with printing only one set of photos containing one or more characters in the group, thereby increasing a customer's service satisfaction.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the following claims, and all differences within the scope will be construed as being included in the present invention.

What is claimed is:

1. A method of providing an automatic sorting packing service sorting photo images according to characters included in the photo images, the method comprising:
extracting a characteristic of each character from a face area of each photo image for which printing has been requested; and
determining whether a detected character is a new character by comparing the extracted characteristic with a characteristic stored in a database,
if the detected character is determined to be a new character, storing the extracted characteristic in the database, allocating a new packing line to the detected character, and adding a corresponding photo image to the allocated packing line, and
if the detected character is determined to be a character that has previously been recorded in the database, adding the corresponding photo image to the packing line of the detected character.

2. The method of claim 1, wherein the extracting, determining, storing, and adding processes are repeatedly performed for each of the photo images to be printed.

3. The method of claim 1, wherein, in the extracting of the characteristic, when a plurality of characters are found in the same photo image, the determining, storing, and adding processes are repeatedly performed for each character.

4. The method of claim 1, wherein the packing line is realized as a buffer memory that is a storage space allocated to each character,
wherein, in the adding of the corresponding photo image, an ID of the photo image is stored in the packing line.

5. The method of claim 4, the ID of a photo image is an ID number allocated to the each photo image or a file name of the each photo image.

6. The method of claim 4, further comprising, after adding corresponding photo image, printing photo images with IDs included in a packing line of each character.

7. The method of claim 1, wherein the packing lines are realized as receipt trays that are spaced apart from each other, as output locations allocated to characters, in order to spatially divide output photo prints that are to be distributed to each character.

8. The method of claim 7, wherein, in the adding of corresponding photo image, a corresponding photo image is printed to a receipt tray allocated to the character.

9. A method of providing an automatic sorting packing service sorting photo images according to characters included in the photo images, the method comprising:
recognizing characters from each of the photo images for which printing is requested;
preparing a data table in such a way as to retain the association between the photo images and characters thereof; and
allocating a packing line to a character that is to be printed, and adding a photo image capturing the character that is to be printed in the allocated packing line based on the data table.

10. The method of claim 9, wherein the packing line is realized as a buffer memory that is a storage space allocated to each character,
wherein, in the adding a photo image, an ID of a corresponding photo image is stored in the packing line.

11. The method of claim 10, further comprising, after allocating the packing line, printing photo images with IDs stored in a packing line of each character.

12. The method of claim 9, wherein the packing lines are realized as receipt trays that are spaced apart from each other, as output locations allocated to characters, in order to spatially divide output photo prints that are to be distributed to each character.

13. The method of claim 12, wherein, in the adding a photo image, a corresponding photo image is printed to a receipt tray allocated to the character.

14. The method of claim 9, further comprising, after preparing the data table, guiding a user's selection of characters that are to be printed or that are not to be printed.

15. A method of providing an automatic sorting packing service sorting photo images according to characters included in the photo images, the method comprising:
extracting characteristic of each character from photo images for which printing is requested; and
determining whether a detected character is to be printed based on the extracted characteristic,
if it is determined that the detected character is to be printed, storing an ID of a corresponding photo image in a packing line allocated to the detected character; and
printing photo images with the IDs stored in a packing line of each character.

16. The method of claim 15, further comprising, after extracting the characteristic, displaying photo images of characters that are detected in the photo images for which printing has been requested, and guiding a user's input of characters that are to be printed or that are not to be printed.

17. The method of claim 15, further comprising, after extracting the characteristic, displaying photo images of characters that are detected in the photo images for which printing is requested, and guiding a user's input for establishing a relationship between the characters.

18. The method of claim 17, wherein the determining of whether the detected character is to be printed comprises:
determining whether the detected character belongs to a group for which a relationship has been established by the user;
if the detected character is a character for which a relationship has been established, identifying whether the ID of a corresponding photo image is stored in a packing line of another character that is related to the detected character and belongs to the group; and
if the detected character is not a character for which a relationship has been established, or although the detected character is the character for which relationship is established, if the ID of the corresponding photo image is not stored in the packing line of another character that is related to the detected character, determining the detected character is to be printed.

19. A kiosk providing an automatic sorting packing service sorting according to characters, the kiosk comprising:
a face recognizing unit searching for a face area of a photo image, for which printing is requested, and extracting a characteristic from the face area; and
a controller determining whether a detected character is a new character by comparing the extracted characteristic with a characteristic stored in a database,
if the detected character is determined to be a new character, storing the extracted characteristic in the database, allocating a new packing line to the detected character, and adding a corresponding photo image in the allocated packing line, and
if the detected character is determined to be a character that has previously been recorded in the database, adding the corresponding photo image to the packing line of the detected character.

20. The kiosk of claim 19, wherein the packing line is realized as a buffer memory that is a storage space allocated to each character,
wherein the controller stores an ID of a corresponding photo image in the packing line.

21. The kiosk of claim 20, further comprising: a printing unit printing photo images with IDs stored in the buffer memory allocated to each character.

22. The kiosk of claim 19, wherein the packing lines are realized as receipt trays that are spaced apart from each other, as output locations allocated to characters, in order to spatially divide output photo prints that are to be distributed to each character.

23. The kiosk of claim 22, wherein the controller operates a printing unit to print a corresponding photo image to a receipt tray allocated to the character.
